(19) United States
(12) Patent Application Publication
(10) Pub. No.: US 2025/0252001 A1
(43) Pub. Date: Aug. 7, 2025

(54) DATA TRANSFER CONTROLLER AND INFORMATION PROCESSING APPARATUS

(71) Applicants: Fujitsu Limited, Kawasaki-shi (JP); NIPPON TELEGRAPH AND TELEPHONE CORPORATION, Tokyo (JP)

(72) Inventors: Osamu SHIRAKI, Kawasaki (JP); Teruaki Ishizaki, Musashino (JP); Sampath Priyankara, Musashino (JP); Takahiro Kawahara, Musashino (JP)

(73) Assignees: Fujitsu Limited, Kawasaki-shi (JP); NIPPON TELEGRAPH AND TELEPHONE CORPORATION, Tokyo (JP)

(21) Appl. No.: 19/024,954

(22) Filed: Jan. 16, 2025

(30) Foreign Application Priority Data
Feb. 1, 2024 (JP) 2024-014078

(51) Int. Cl. G06F 9/54

(52) U.S. Cl. CPC G06F 9/546

(57) ABSTRACT

A data transfer controller includes a receiver which receives, from a transmitting device, a message including a destination identifying a receiving device which acquires data from a storage area and processes the acquired data, and an address indicating a storage destination of the data to be processed by the receiving device, a transmission queue which retains the message received by the receiver, a copy processing device which instructs the transmitting device to copy the data retained in the transmitting device to a memory, and rewrites an address included in the message retained in the transmission queue to an address indicating a storage location of the data in the memory, based on copying of the data from the transmitting device to the memory, and a transmitter configured to transmit the message retained at a head of the transmission queue to the receiving device indicated by the destination included in the message.

### CROSS-REFERENCE TO RELATED APPLICATIONS

This application is based upon and claims the benefit of priority of the prior Japanese Patent Application No. 2024-014078, filed on Feb. 1, 2024, the entire contents of which are incorporated herein by reference.

### FIELD

The embodiments discussed herein are related to data transfer controllers and information processing apparatuses.

### BACKGROUND

In a serial interface control device, there is a known method of generating and transmitting a frame by combining control information stored in a memory and transmission data stored in a buffer using a frame composite circuit (refer to Japanese Laid-Open Patent Publication No. H10-69459, for example).

In a case where data is directly transferred between device interfaces, there is a known method of controlling the data transfer based on access permissions of a data block of a transfer source included in access control information retained in a control information storage unit (refer to Japanese Laid-Open Patent Publication No. H9-73412, for example).

In a direct memory access (DMA) controller which transfers data between storage areas, there is a known method of repeating the data transfer without intervention of a central processing unit (CPU), according to data transfer information retained in queues having different priorities (refer to Japanese Laid-Open Patent Publication No. 2005-165439, for example).

In a data transfer system, there is a known method of transmitting a message including identification information for identifying a receiving device and a communication task, from a transmitting device to a plurality of receiving devices, and transmitting data from the transmitting device to the receiving device which is unsuppressed of the communication task (refer to Japanese Laid-Open Patent Publication No. 2012-88753, for example).

For example, a data transfer method, such as function chaining or the like, is known. The function chaining arranges a plurality of devices (functions) having multiple functions on a bus, and directly transfers data between predetermined devices. In this type of data transfer method, in a case where the data is resident in a transmitting device depending on a processing speed or a processing load of the receiving device, the data transfer from the transmitting device to another receiving device may be delayed, and a performance of the entire system may deteriorate.

### SUMMARY

Accordingly, it is an object in one aspect of the embodiments to prevent, even in a case where a process of a receiving device is delayed, a delay in a process of another receiving device which receives a message transmitted from a transmitting device.

According to one aspect of the embodiments, a data transfer controller includes a receiver configured to receive, from a transmitting device, a message including a destination identifying a receiving device which acquires data from a storage area and processes the acquired data, and an address indicating a storage destination of the data to be processed by the receiving device; a transmission queue configured to retain the message received by the receiver; a copy processing device configured to instruct the transmitting device to copy the data retained in the transmitting device to a memory, and rewrite an address included in the message retained in the transmission queue to an address indicating a storage location of the data in the memory, based on copying of the data from the transmitting device to the memory; and a transmitter configured to transmit the message retained at a head of the transmission queue to the receiving device indicated by the destination included in the message.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an information processing apparatus having a data transfer controller according to an embodiment;

FIG. 2 is a flow chart illustrating an example of an operation of the data transfer controller illustrated in FIG. 1;

FIG. 3 is a flow chart illustrating an example of an operation of a receiving device which receives a message in FIG. 1;

FIG. 4 is a block diagram illustrating an example of the information processing apparatus having the data transfer controller according to another embodiment;

FIG. 5 is a block diagram illustrating an example of a hardware configuration of an information processing apparatus illustrated in FIG. 4;

FIG. 6 is a block diagram illustrating an example of a functional configuration of a message management device illustrated in FIG. 4;

FIG. 7 is a diagram illustrating examples of information included in the message illustrated in FIG. 4 and completion waiting information retained in a completion waiting queue;

FIG. 8 is a block diagram illustrating an example of a memory management unit illustrated in FIG. 6;

FIG. 9 is a diagram for explaining an example of an operation of the information processing apparatus illustrated in FIG. 4;

FIG. 10 is a diagram for explaining another example of the operation of the information processing apparatus illustrated in FIG. 4;

FIG. 11 is a sequence diagram illustrating the operation illustrated in FIG. 10;

FIG. 12 is a diagram for explaining another example of the operation of the information processing apparatus illustrated in FIG. 4;

FIG. 13 is a sequence diagram illustrating the operation illustrated in FIG. 12;

FIG. 14 is a diagram for explaining another example of the operation of the information processing apparatus illustrated in FIG. 4;

FIG. 15 is a sequence diagram illustrating the operation illustrated in FIG. 14;

FIG. 16 is a sequence diagram illustrating the operation illustrated in FIG. 14 continuing from FIG. 15;

FIG. 17 is a diagram for explaining another example of the operation of the information processing apparatus illustrated in FIG. 4;

FIG. 18 is a sequence diagram illustrating the operation illustrated in FIG. 17;

FIG. 19 is a flow chart illustrating an example of the operation of a message receiving unit illustrated in FIG. 6;

FIG. 20 is a flow chart illustrating an example of n operation of step S103 illustrated in FIG. 19;

FIG. 21 is a flow chart illustrating an example of an operation of a copy processing unit illustrated in FIG. 6;

FIG. 22 is a flow chart illustrating an example of an operation of a message transmitting unit illustrated in FIG. 6; and

FIG. 23 is a flow chart illustrating an example of an operation of a completion waiting queue illustrated in FIG. 6.

### DESCRIPTION OF EMBODIMENTS

Preferred embodiments of the present invention will be described with reference to the accompanying drawings.

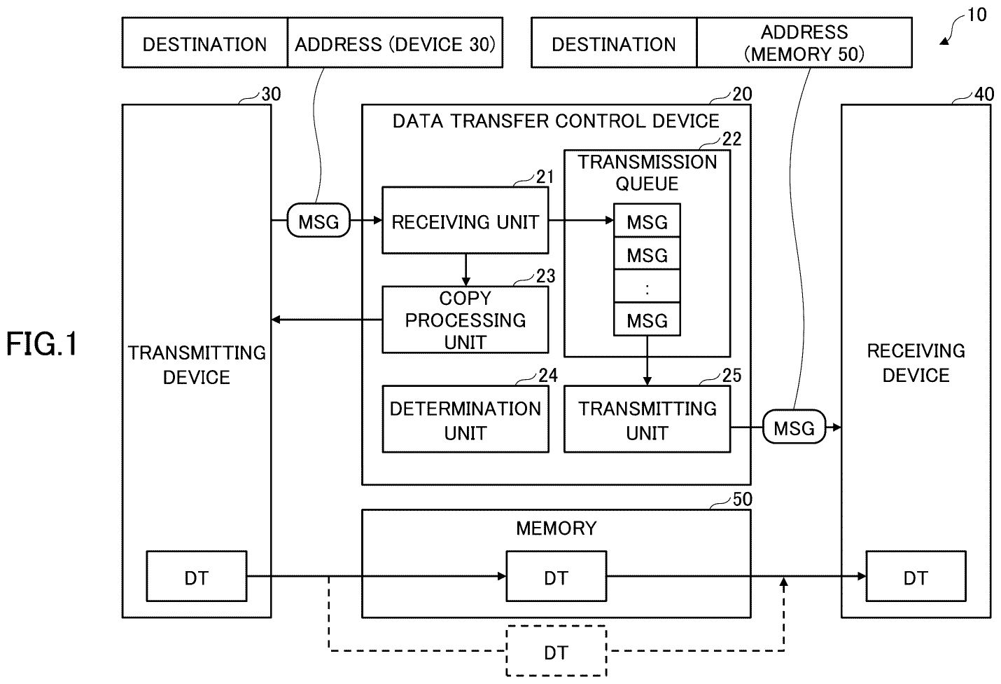

FIG. 1 illustrates an example of an information processing apparatus having a data transfer controller according to an embodiment. An information processing apparatus 10 illustrated in FIG. 1 includes a data transfer controller 20, a transmitting device 30, a receiving device 40, and a memory 50. The data transfer controller 20 includes a receiving unit (or a receiver) 21, a transmission queue 22, a copy processing unit (or a copy processing device) 23, a determination unit (or a determination device) 24, and a transmitting unit (or a transmitter) 25.

Although not illustrated, the data transfer controller 20, the transmitting device 30, the receiving device 40, and the memory 50 may be connected to one another via a bus. For example, the transmitting device 30 and the receiving device 40 may be a field programmable gate array (FPGA), a graphics processing unit (GPU), or the like. The information processing apparatus 10 may implement the function chaining which transfers data directly among a plurality of devices having a predetermined processing function, respectively, and successively processes the data by the plurality of devices.

The transmitting device 30 retains data DT to be processed by the receiving device 40 in a memory (not illustrated) or the like provided in the transmitting device 30. The transmitting device 30 transmits a message MSG, including a destination identifying the receiving device 40 which is to process the data DT and an address indicating a storage destination of the data DT to be processed by the receiving device 40, to the data transfer controller 20. For example, the address is a head address of a storage area where the data is retained in a memory space used in the information processing apparatus 10. The message MSG may include a size of the data DT.

In the data transfer controller 20, the receiving unit 21 receives the message MSG including the destination and the address. The message MSG received by the receiving unit 21 is successively retained in entries of a first-in first-out (FIFO) transmission queue 22.

The determination unit 24 determines whether or not a residence time (or a prediction value) of the message MSG in the transmission queue 22 exceeds a first time. In a case where the residence time (or the prediction value) exceeds the first time, the copy processing unit 23 transmits to the transmitting device 30 an instruction to copy the data DT retained in the transmitting device 30 to the memory 50.

The copy processing unit 23 rewrites the address included in the message MSG retained in the transmission queue 22 to an address indicating a storage location of the data DT in the memory 50, in response to the copying of the data DT from the transmitting device 30 to the memory 50. In a case where the residence time (or the prediction value) is less than or equal to the first time, the copy processing unit 23 does not rewrite the address included in the message MSG retained in the transmission queue 22. In this case, the address included in the message MSG indicates a storage area where the data DT is retained in the transmitting device 30.

The transmitting unit 25 transmits the message MSG retained at the head of the transmission queue 22 to the receiving device 40 indicated by the destination included in the message MSG. FIG. 1 illustrates an operation for the case where the residence time of the message MSG in the transmission queue 22 exceeds the first time. For this reason, the address of the message MSG transmitted from the transmitting unit 25 to the receiving device 40 indicates the memory 50 where the data DT is stored.

In a case where the receiving device 40 receives the message MSG, the receiving device 40 acquires the data DT from the storage area indicated by the address included in the message MSG, and processes the acquired data DT. In the example illustrated in FIG. 1, the receiving device 40 acquires the data DT from the memory 50. In a case where the residence time does not exceed the first time, the receiving device 40 acquires the data DT from a storage area in the transmitting device 30, as indicated by a transfer path of the data DT indicated by a broken line.

For example, in a case where the processing of the data DT retained in the storage area of the transmitting device 30 is delayed due to slow processing of the data DT by the receiving device 40, the storage area for storing the data in the transmitting device 30 becomes constrained, and new data DT cannot be transmitted. As a result, the message MSG transmitted from the transmitting device 30 to receiving devices other than the receiving device 40 is also delayed. As described above, due to the slow processing of the receiving device 40, the processing of other receiving devices may be delayed.

In this embodiment, the data DT to be processed by the receiving device 40 is copied to the memory 50 without being continuously retained in the transmitting device 30. Hence, the transmitting device 30 can transmit the message MSG with respect to another device to the data transfer controller 20 without delay. As a result, it is possible to reduce the delay in the processing of the other devices caused by the delay in the processing of the receiving device 40.

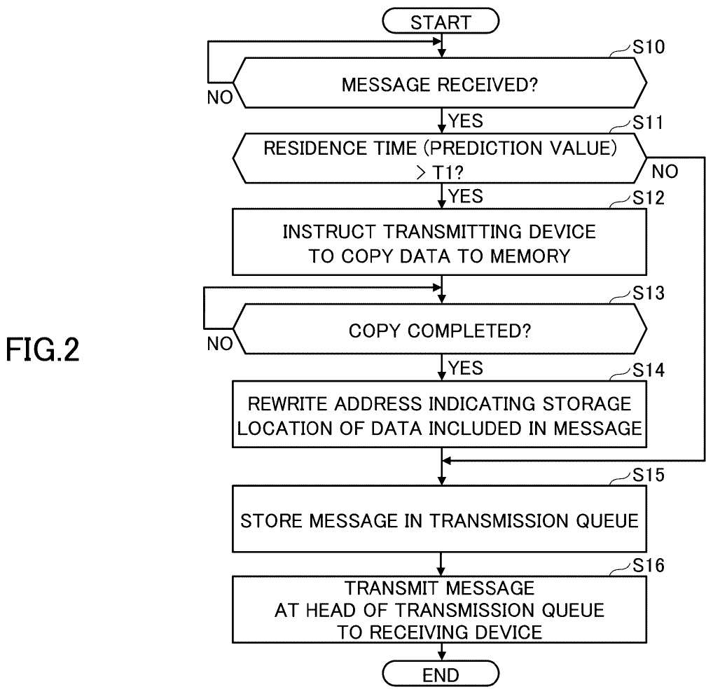

FIG. 2 illustrates an example of an operation flow of the data transfer controller 20 illustrated in FIG. 1. First, in step S10, the data transfer controller 20 waits until the message MSG is received, and in a case where the message MSG is received, the data transfer controller 20 performs a process of step S11. In step S11, the data transfer controller 20 determines whether or not the residence time (or the prediction value) of the message MSG in the transmission queue 22 exceeds a first time T1. The data transfer controller 20 performs step S12 in a case where the prediction value of the residence time exceeds the first time T1, and performs a process of step S15 in a case where the prediction value of the residence time is less than or equal to the first time T1.

In step S12, the data transfer controller 20 transmits, to the transmitting device 30 at a transmission source of the message MSG, an instruction to copy the data retained in the transmitting device 30 to the memory 50. Next, in step S13, the data transfer controller 20 waits until the copying of the data DT from the transmitting device 30 to the memory 50 is completed, and in a case where the copying is completed, the data transfer controller 20 performs a process of step S14. For example, the data transfer controller 20 determines the completion of the copying of the data DT from the transmitting device 30 to the memory 50, based on a copying complete notification from the transmitting device 30 to the data transfer controller 20.

Next, in step S14, the data transfer controller 20 rewrites the address indicating the storage location of the data DT included in the received message MSG, to the address indicating the storage location of the data DT in the memory 50. Next, in step S15, the data transfer controller 20 stores the message MSG in the transmission queue 22. Next, in step S16, the data transfer controller 20 transmits the message MSG retained at the head of the transmission queue 22, to the receiving devices 40 indicated by the destination included in the message MSG, and ends the operation illustrated in FIG. 2.

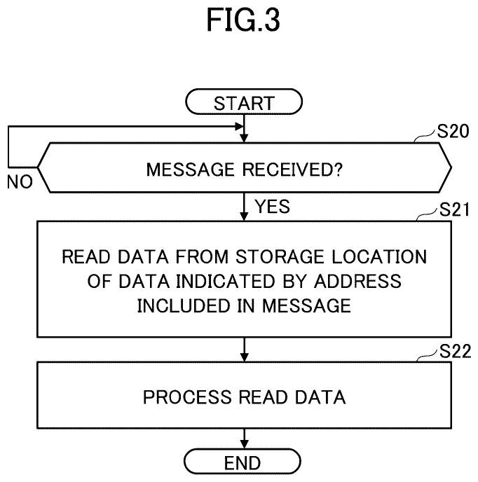

FIG. 3 illustrates an example of an operation flow of the receiving device 40 which receives the message MSG in FIG. 1. First, in step S20, the receiving device 40 waits until the message MSG is received, and in a case where the message MSG is received, performs a process of step S21. In step S21, the receiving device 40 reads the data DT from the storage location of the data DT indicated by the address included in the message MSG. Next, in step S22, the receiving device 40 processes the read data DT, and ends the operation illustrated in FIG. 3.

As described above, in this embodiment, the data transfer controller 20 copies the data to be processed by the receiving device 40 in which the process is delayed, from the transmitting device 30 to the memory 50, and causes the receiving device 40 to acquire the data. Hence, it possible to reduce the delay in the data processing of other receiving device which receive the data from the transmitting device 30. As a result, it is possible to prevent a deterioration in a processing performance of the information processing apparatus 10 including the plurality of transmitting devices 30 and the plurality of receiving devices 40.

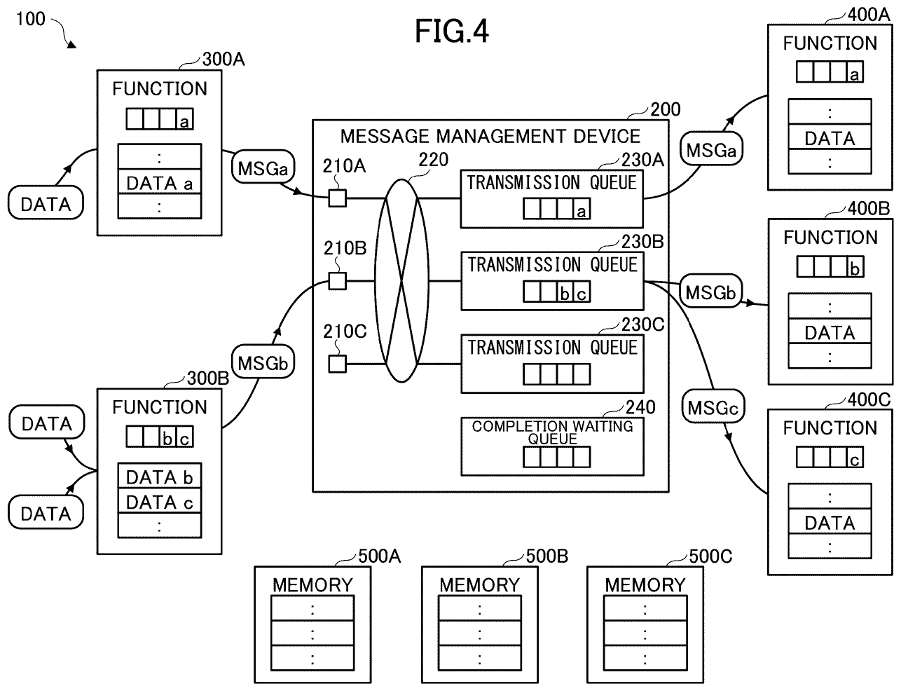

FIG. 4 illustrates an example of the information processing apparatus having the data transfer controller according to another embodiment. An information processing apparatus 100 illustrated in FIG. 4 may implement the function chaining which transfers the data directly among a plurality of devices having a predetermined processing function, respectively, and successively processes the data by the plurality of devices, for example.

The information processing apparatus 100 includes a message management device 200, a plurality of functions 300A, 300B, 400A, 400B, and 400C, and a plurality of memories 500A, 500B, and 500C. The message management device 200 is an example of a data transfer controller. The functions 300A and 300B are examples of the transmitting device, and the functions 400A, 400B, and 400C are examples of the receiving device.

Hereinafter, the functions 300A and 300B are also referred to as functions 300 when not distinguishing these two functions 300A and 300B. The functions 400A, 400B, and 400C are also referred to as functions 400 when not distinguishing these three functions 400A, 400B, and 400C. The memories 500A, 500B, and 500C are also referred to as memories 500 when not distinguishing these three memories 500A, 500B, and 500C.

The message management device 200 includes input ports 210A, 210B, and 210C, a router 220, transmission queues 230A, 230B, and 230C, and a completion waiting queue 240. Hereinafter, the input ports 210A, 210B, and 210C are also referred to as input ports 210 when not distinguishing these three input ports 210A, 210B, and 210C. The transmission queues 230A, 230B, and 230C are also referred to as transmission queues 230 when not distinguishing these three transmission queues 230A, 230B, and 230C. The message management device 200 may be implemented by hardware, such as a FPGA or the like. In addition, a part of the functions of the message management device 200 may be implemented by software.

Each of the functions 300 and 400 includes a queue for retaining a message MSG (MSGa, MSGb, or MSGc) and a data retaining unit, such as a memory or the like for retaining data. The queue of each of the functions 300 and 400 is indicated by four rectangles arranged in a horizontal direction illustrated in FIG. 4, and the data retaining unit of each of the functions 300 and 400 is indicated by three rectangles arranged in a vertical direction illustrated in FIG. 4.

For example, each of the functions 300 and 400 has a function of processing data, and is implemented by a device, such as a FPGA, a GPU, or the like. Hereinafter, the device, such as the FPGA, the GPU, or the like which implements the function 300 or 400 is also referred to as the function 300 or 400. Each memory 500 includes a plurality of blocks capable of retaining data to be processed by the function 400.

The message management device 200 receives a message reception request from each function 400 in advance, associates each function 400 with one of the transmission queues 230, and registers a corresponding relationship between each function 400 and the transmission queue 230. Further, the message MSG retained in each transmission queue 230 is transmitted to the corresponding function 400.

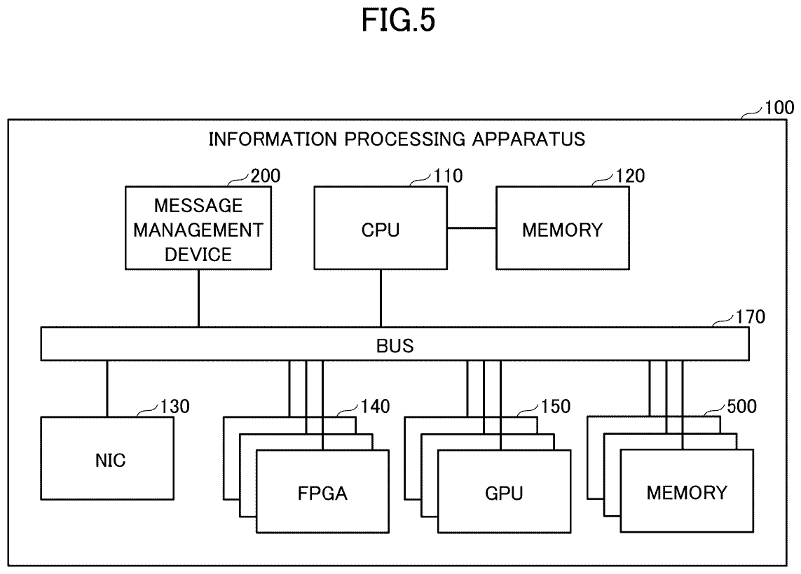

FIG. 5 illustrates an example of a hardware configuration of the information processing apparatus 100 illustrated in FIG. 4. The information processing apparatus 100 includes a message management device 200, a CPU 110, a memory 120, a network interface controller (NIC) 130, a plurality of FPGAs 140, a plurality of GPUs 150, a plurality of memories 500, and a bus 170.

The message management device 200, the CPU 110, the NIC 130, the plurality of FPGAs 140, the plurality of GPUs 150, and the plurality of memories 500 are connected to one another via the bus 170, such as a peripheral component interconnect express (PCIe) bus or the like. The memory 120 is connected to the CPU 110 without using the bus 170. For example, the CPU 110 may control the entire information processing apparatus 100 by executing a control program stored in the memory 120.

The NIC 130 controls a connection to a network NW, and inputs and outputs various kinds of information to and from the network NW. Each of the FPGAs 140 and the GPUs 150 corresponds to the function 300 or 400 illustrated in FIG. 4, and implements the functionality of the function 300 or 400.

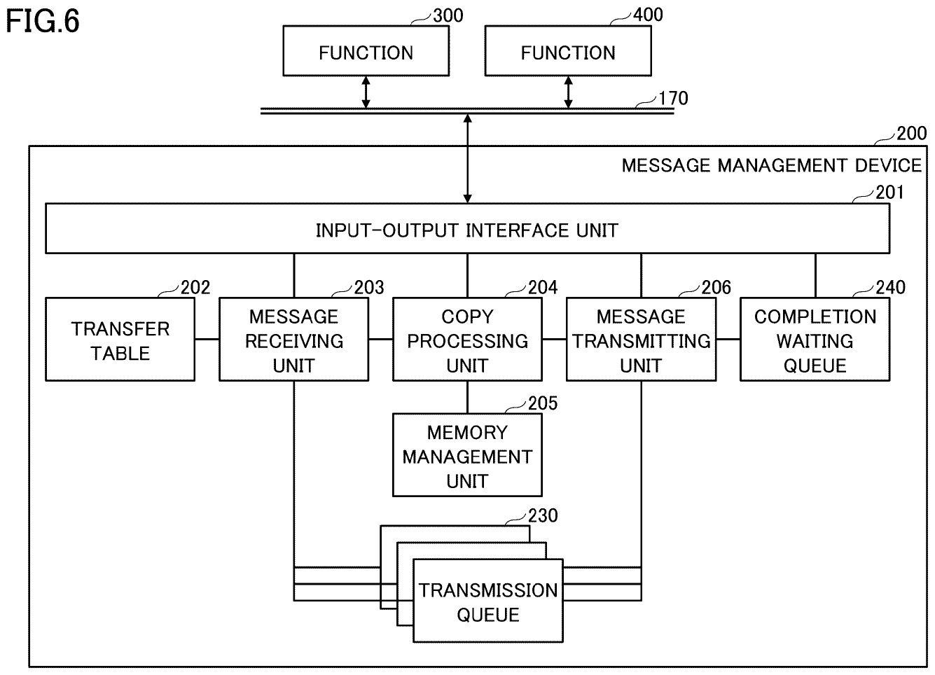

FIG. 6 illustrates an example of a functional configuration of the message management device 200 illustrated in FIG. 4. The message management device 200 includes an input-output interface unit 201, a transfer table 202, a message receiving unit 203, a copy processing unit 204, a memory management unit 205, a message transmitting unit 206, a completion waiting queue 240, and a plurality of transmission queues 230. The message receiving unit 203 is an example of the receiving unit and the determining unit, and the message transmitting unit 206 is an example of the transmitting unit.

The input-output interface unit 201 is connected to the bus 170, receives the message MSG from the function 300, and outputs the message MSG to the function 400. The transfer table 202 retains information indicating the transmission queue 230 which is to store the message MSG received from the function 300. For example, the transfer table 202 retains information indicating a correspondence between the destination included in the message MSG and the transmission queues 230.

The message receiving unit 203 receives the message MSG transmitted from the function 300 via the input-output interface unit 201. The message receiving unit 203 refers (or makes access) to the transfer table 202 to find the transmission queue 230 which is to store the received message MSG, and stores the message MSG in the found transmission queue 230.

In addition, the message receiving unit 203 determines whether or not to copy, to the memory 500, the data retained in the function 300 at the transmission source of the message MSG. In a case where the data is to be copied, the message receiving unit 203 instructs the copy processing unit 204 to perform a copy process.

The copy processing unit 204 determines the memory 500 to which the data is to be copied, and causes the function 300 at the transmission source of the message MSG to copy the data. The memory management unit 205 includes a management table which retains information indicating whether or not a plurality of blocks included in each of the plurality of memories 500 are used.

The message transmitting unit 206 transmits the message MSG retained in the head entry of each transmission queue 230 to the function 400 indicated by the destination included in the message MSG. In a case where the message MSG is multicast or the data is copied to the memory 500, the message transmitting unit 206 stores completion waiting information in the completion waiting queue 240.

The completion waiting queue 240 is used to confirm that a response is received from all of the functions 400 at the multicast destinations. In addition, the completion waiting queue 240 is used to relay a transfer complete notification to the function 300 for the case where the data is transferred to the function 400 via the memory 500.

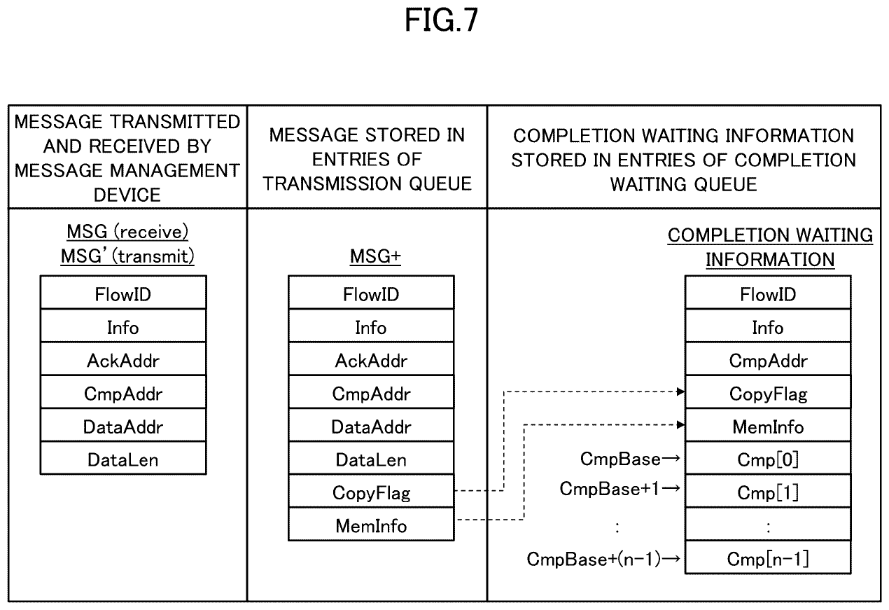

FIG. 7 illustrates examples of information included in the message MSG illustrated in FIG. 4 and completion waiting information retained in the completion waiting queue 240. The message MSG received by the message management device 200 from the function 300 and a message MSG' transmitted from the message management device 200 to the function 400 include items common to each other.

The messages MSG and MSG' have areas for retaining FlowID, Info, AckAddr, CmpAddr, DataAddr, and DataLen. The FlowID indicates a number for identifying the message MSG. For example, the message receiving unit 203 selects the transmission queue 230 which is to store the message MSG, based on the FlowID.

The Info includes various information used by the message management device 200, and is an example of additional information. For example, the Info includes information specifying a forced copying of the data to be processed from the function 300 to the memory 500, or information designating the memory 500 to which the data to be processed is to be copied, or the like.

The AckAddr indicates an address of an area for storing success (ACK) or failure (NAK) of reception of the message MSG. For example, the AckAddr included in the message MSG which is received by the message management device 200 from the function 300 indicates the address of the area accessible by the function 300. The AckAddr included in the message MSG' transmitted from the message management device 200 indicates an address of an area accessible by the function 300, or an address of an area accessible by the message management device 200.

The CmpAddr indicates a write address of an area to which a data transfer complete CMP, which is a complete notification of the copying of the data from the memory 500 by the function 400, is to be written. The CmpAddr included in the message MSG received by the message management device 200 from the function 300 indicates a write address of an area accessible by the function 300.

The CmpAddr included in the message MSG′ transmitted from the message management device 200 indicates a write address of an area accessible by the function 300, in a case where the function 400 acquires the data from the function 300. The CmpAddr included in the message MSG' transmitted from the message management device 200 indicates a write address of an area accessible by the message management device 200, in a case where the function 400 acquires the data from the memory 500.

The DataAddr indicates a head address (or a data storage location) of a memory area where the data to be processed is stored. The DataAddr included in the message MSG received by the message management device 200 indicates an address assigned to the data retaining unit of the function 300. The DataAddr included in the message MSG' transmitted from the message management device 200 indicates an address assigned to the data retaining unit of the function 300 or an address assigned to the memory 500. The DataLen indicates a data length (or a data size) of the data transferred from the function 300 to the function 400.

A message MSG+ stored in the entry of the transmission queue 230 is generated by adding CopyFlag and MemInfo to the message MSG received by the message management device 200. The CopyFlag is an example of a copy flag indicating whether or not the data is copied from the function 300 to the memory 500. The MemInfo includes information for identifying a location (the data retaining unit or the memory 500 at the transmission source of the message MSG) where the data to be processed by the function 400 is stored.

The completion waiting information retained in the completion waiting queue 240 includes FlowID, Info, CmpAddr, CopyFlag, MemInfo, and n Cmps. The FlowID, the Info, the CmpAddr, the CopyFlag, and the MemInfo are the same as the elements included in the message MSG+retained in the transmission queue 230.

Each Cmp is a completion flag where the data transfer complete CMP received from the corresponding function 400 is stored. The address of each completion flag Cmp is assigned in an order from an address CmpBase. Hereinafter, the addresses CmpBase, CmpBase+1, . . . , CmpBase+(n-1) are also referred to as the address CmpBase.

In a case where the message MSG is multicast, the message transmitting unit 206 rewrites the CmpAddr of the message MSG' to the address CmpBase assigned to the corresponding completion flag Cmp in the completion waiting information, before transmitting each message MSG to each function 400.

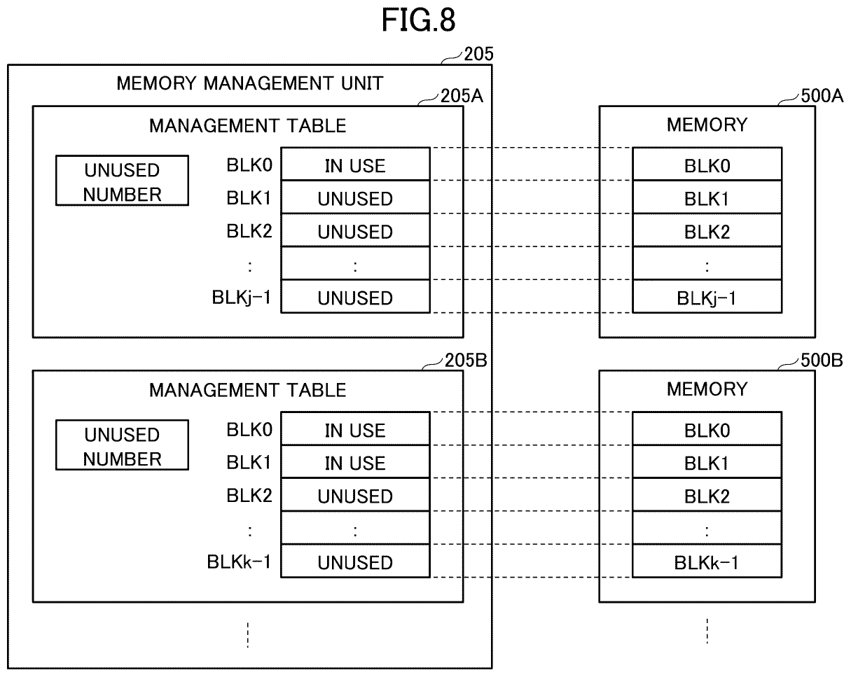

FIG. 8 illustrates an example of the memory management unit 205 illustrated in FIG. 6. The memory management unit 205 includes a plurality of management tables 205A, 205B, . . . corresponding to the plurality of memories 500 (500A, 500B, . . . ), respectively. For example, each memory 500 is partitioned into a plurality of blocks BLK, such as j blocks or k blocks. Each of the management tables 205A, 205B, . . . includes an area where information indicating whether each block BLK of the corresponding memory 500 is in use or unused is stored, and an area where an unused number, that is, a number of unused blocks BLK, is stored.

For example, in the case where the data is to be copied from the function 300 to the memory 500A, the copy processing unit 204 sets the area of the management table 205A corresponding to the block BLK to which the data is copied in the memory 500A to “in use”. Further, the copy processing unit 204 stores the number of unused blocks BLK of the memory 500A in the area of the “unused number”. Moreover, in a case where the memory 500A is released, the copy processing unit 204 returns the area set to “in use” in the management table 205A to “unused”, and updates the “unused number”. The memory management unit 205 may include a management table for managing the blocks of the memory, such as the data retaining unit or the like of the function 300.

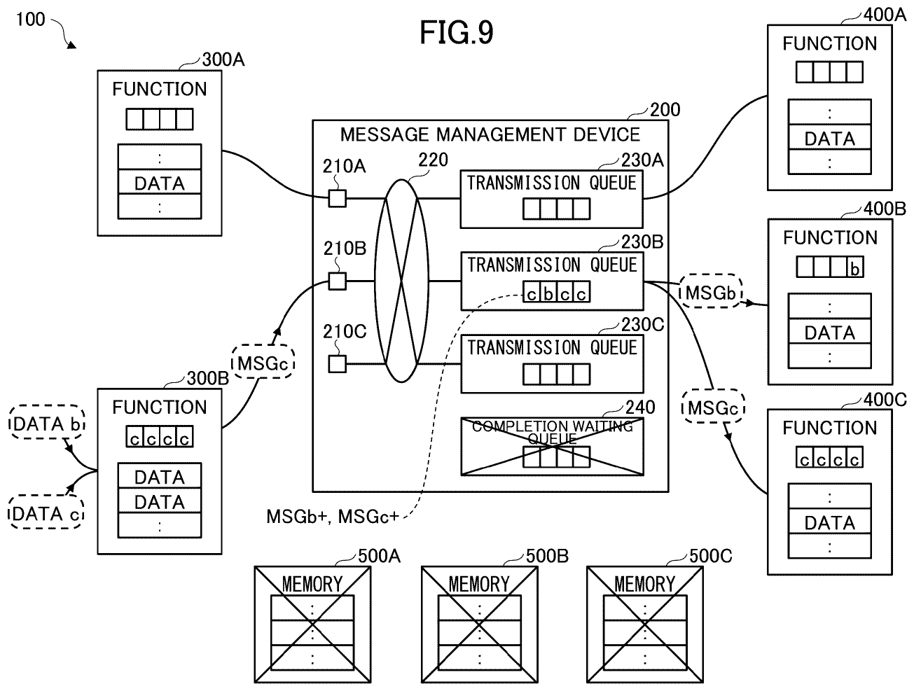

FIG. 9 illustrates an example of an operation of the information processing apparatus 100 illustrated in FIG. 4. FIG. 9 illustrates an example of a malfunction in a case where the message management device 200 is operated without using the completion waiting queue 240 and the memories 500A, 500B, and 500C. FIG. 9 illustrates an example in which the function 300B receives the messages to be processed by the functions 400B and 400C, respectively, and outputs messages MSGb and MSGc to the functions 400B and 400C via the message management device 200.

In a case where the completion waiting queue 240 and the memories 500A, 500B, and 500C are not used, the functions 400B and 400C read the data to be processed directly from the data retaining unit of the function 300B. For example, in FIG. 9, the delay in processing the data by the function 400C causes the data retained in the data retaining unit of the function 300B to become resident (or accumulate) without being transmitted, and it becomes impossible to transmit new data.

For this reason, it is difficult for the function 300B to receive new data b and new data c to be processed by the functions 400B and 400C. That is, due to the delay in the processing of the data by the function 400C, the message MSGb does not reach the function 400B which performs the processing different from the processing of the function 400C, and a problem is generated in that the processing by the function 400B is delayed.

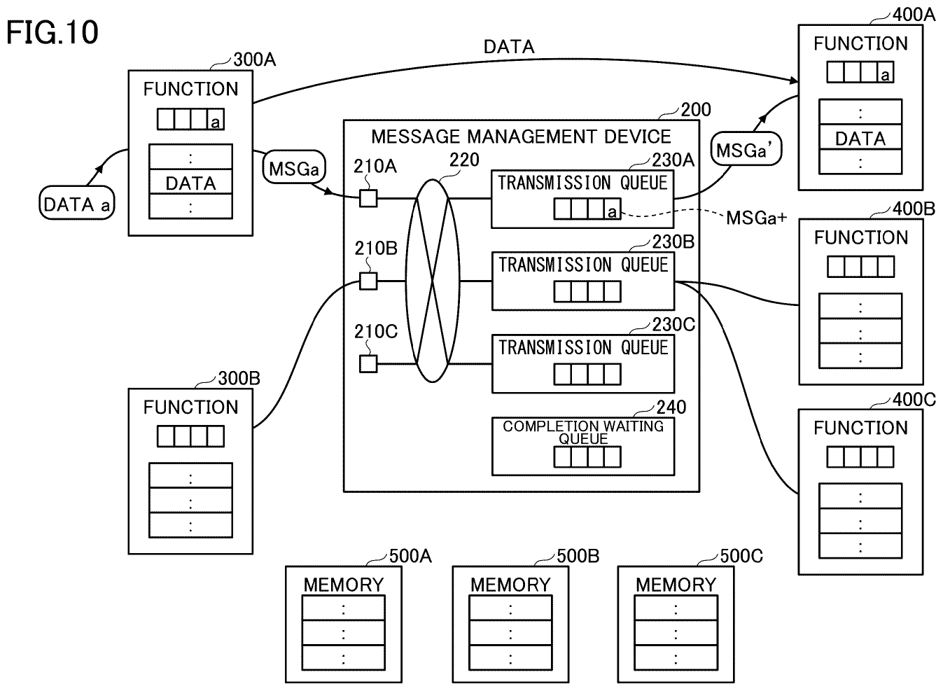

FIG. 10 illustrates another example of the operation of the information processing apparatus 100 illustrated in FIG. 4. In FIG. 10, in a state where the data retaining unit of the function 300A has a sufficient storage capacity, a single-cast message MSGa is transmitted from the function 300A to the function 400A via the message management device 200. In the case where the data retaining unit of the function 300A has the sufficient storage capacity, the data to be processed by the function 400A is transferred directly from the function 300A to the function 400A and not via the memory 500.

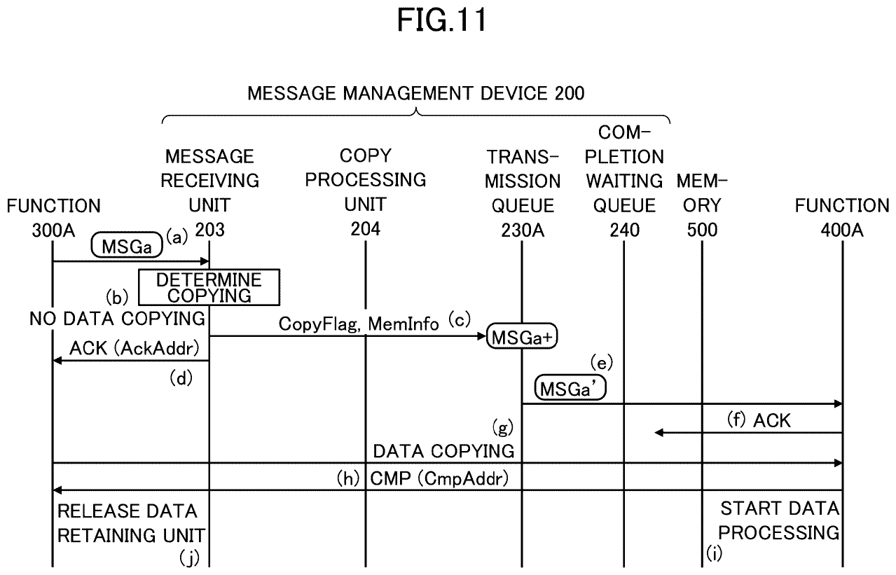

FIG. 11 is a sequence diagram illustrating the operation illustrated in FIG. 10. The function 300A transmits the message MSGa to the message management device 200, as indicated by (a) in FIG. 11. In the message MSGa, the FlowID illustrated in FIG. 7 is set to a number for identifying the message MSG, and the AckAddr and the CmpAddr are set to addresses indicating predetermined areas within the function 300A, respectively. The DataAddr and the DataLen indicate the head address and the data length of the memory within the function 300 which retains the data to be processed by the function 400A, respectively.

The message receiving unit 203, which receives the message MSGa, determines that the data retaining unit of the function 300A has a sufficient storage capacity because the residence time (that is, the processing speed) of the message MSGa retained in the transmission queue 230A is shorter than a threshold value, for example. Then, the message receiving unit 203 determines not to copy the data to the memory 500, as indicated by (b) in FIG. 11. The message receiving unit 203 searches the transfer table 202 illustrated in FIG. 6 using the FlowID, and determines to store the message MSGa in the transmission queue 230A. In the case where the residence time (processing speed) of the message MSGa retained in the transmission queue 230A is short, the message management device 200 does not cause the function 300 to transfer the data to the memory 500. For this reason, the message receiving unit 203 stores the message MSGa+, which includes the CopyFlag indicating no data copying and the MemInfo indicating information for identifying the data retaining unit of the function 300A, in the transmission queue 230A, as indicated by (c) in FIG. 11. The message receiving unit 203 writes the ACK in the area indicated by the AckAddr of the function 300A, as indicated by (d) in FIG. 11.

The message transmitting unit 206 deletes the CopyFlag and the MemInfo from the message MSGat, rewrites the AckAddr to an address indicating an area within the message management device 200, and transmits a message MSGa' to the function 400A, as indicated by (e) in FIG. 11. The function 400A, which receives the message MSGa', writes the ACK (for example, “1”) in the area of the message management device 200 indicated by the AckAddr of the message MSGa, as indicated by (f) in FIG. 11.

The function 400A accesses the storage area of the function 300A indicated by the DataAddr included in the message MSGa', and copies the data having the data length indicated by the DataLen, as indicated by (g) in FIG. 11. After the data copying is completed, the function 400A writes the data transfer complete CMP (for example, “1”) in the area (the function 300A) indicated by the CmpAddr of the message MSGa', as indicated by (h) in FIG. 11. The function 400A starts the data processing using the copied data, as indicated by (i) in FIG. 11. The function 300A, which receives the data transfer complete CMP, releases the area of the data retaining unit that retained the data, as indicated by (j) in FIG. 11. Then, the processing of the single-cast message MSGa for the case where the data is not copied to the memory 500 is completed.

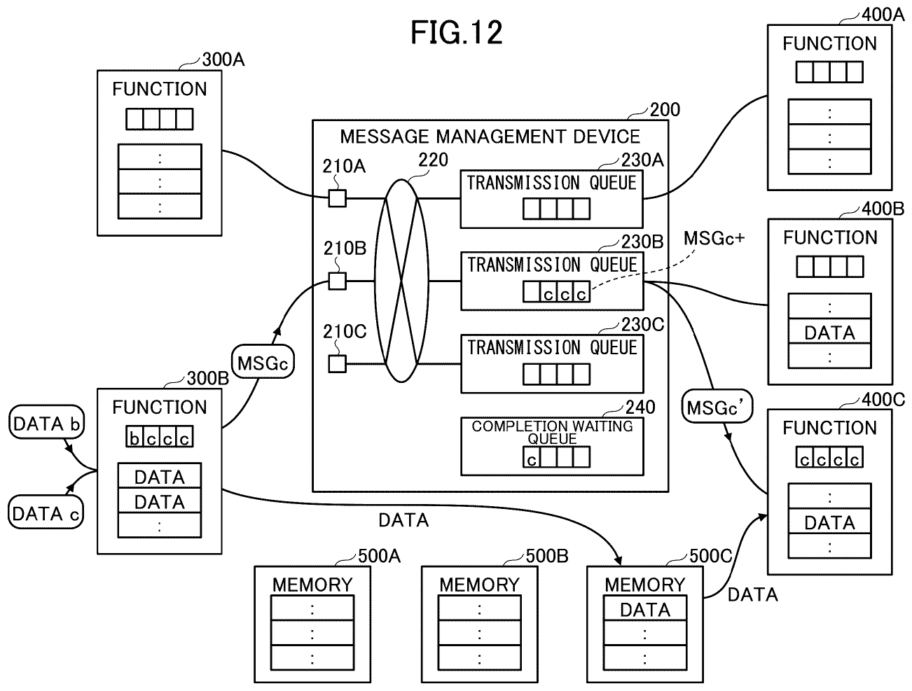

FIG. 12 illustrates another example of the operation of the information processing apparatus 100 illustrated in FIG. 4. In FIG. 12, the single-cast message MSGc is transmitted from the function 300B to the function 400C in a state where the data retaining unit of the function 300B does not have a sufficient storage capacity. In the case where the data retaining unit of the function 300B does not have the sufficient storage capacity, the data to be processed by the function 400C is transferred from the function 300B to the function 400C via the memory 500C, for example.

In a case where the message management device 200 causes the function 300B to transfer the data to the function 400C via the memory 500C, the message management device 200 stores completion waiting information c corresponding to the message MSGc in the completion waiting queue 240. The message management device 200 successively transmits, to the function 400C, a message MSGc' in which the AckAddr indicating the storage destination of the data transfer complete notification is rewritten to the address CmpBase of the completion waiting information. The message management device 200 evicts the head entry (the completion waiting information c) of the completion waiting queue 240 in response to receiving the data transfer complete notification from the function 400C.

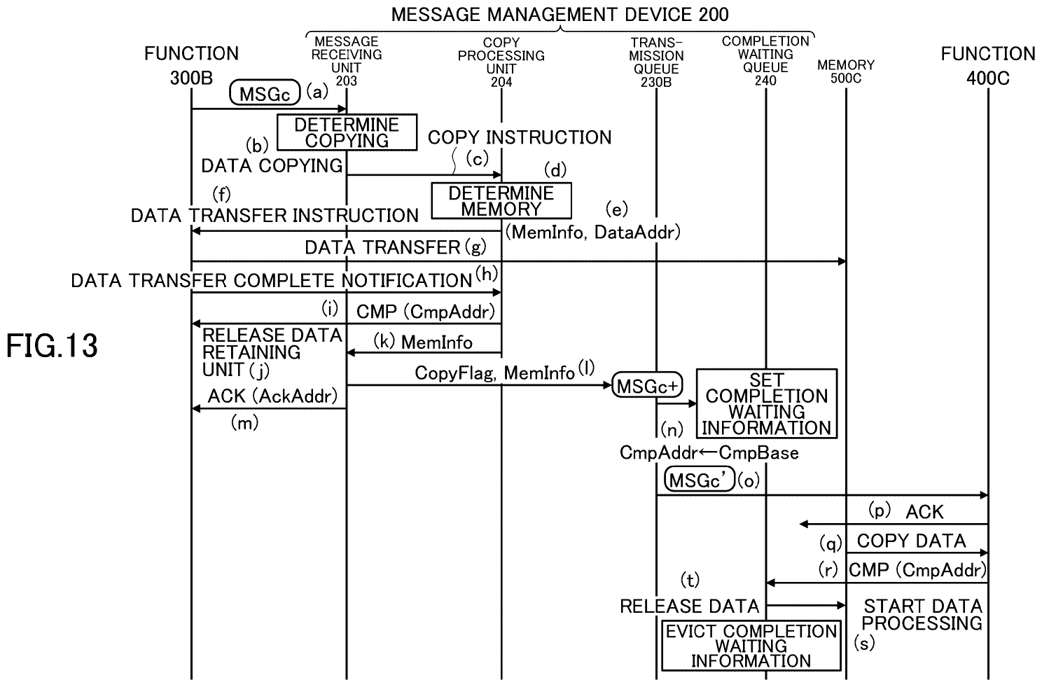

FIG. 13 is a sequence diagram illustrating the operation illustrated in FIG. 12. A detailed description of the same operations as those illustrated in FIG. 11 will be omitted. The function 300B transmits the message MSGc to the message management device 200, as indicated by (a) in FIG. 13. The FlowID, AckAddr, CmpAddr, DataAddr, and DataLen in the message MSGc are set according to the function 400C at the transmitting destination of the message MSGc' and the data to be processed by the function 400C.

The message receiving unit 203, which receives the message MSGa, determines that the data retaining unit of the function 300B has insufficient storage capacity because the residence time (that is, the processing speed) of the message MSGc retained in the transmission queue 230B is shorter than the threshold value, for example. Then, the message receiving unit 203 determines to copy the data to the memory 500C, and instructs the copy processing unit 204 to copy the data, as illustrated by (b) and (c) in FIG. 13. The copy processing unit 204 determines the memory 500C to which the data is to be copied, as illustrated by (d) in FIG. 13. The copy processing unit 204 manages the determined memory 500C as the MemInfo, and stores the head address of the data storage area in the determined memory 500C in the DataAddr of the message MSG, as indicated by (e) in FIG. 13.

The copy processing unit 204 issues a transfer instruction to transfer the data to the memory 500C to the function 300B at the transmission source of the message MSGc, as indicated by (f) in FIG. 13. The function 300B copies the data retained in the data retaining unit to the memory 500C, based on the transfer instruction, and transmits the data transfer complete notification to the copy processing unit 204, as indicated by (g) and (h) in FIG. 13.

The copy processing unit 204 writes the data transfer complete CMP to the completion flag Cmp within the function 300B indicated by the CmpAddr of the message MSGc, and releases the area retaining the data in the function 300B, as indicated by (i) and (j) in FIG. 13. Accordingly, it possible to quickly release the storage area of the function 300B after transferring the data from the function 300 to the memory 500. The copy processing unit 204 notifies the message receiving unit 203 of the MemInfo indicating the memory 500C at the destination of the data transfer and the DataAddr indicating the address of the destination of the data transfer, as indicated by (k) in FIG. 13.

The message receiving unit 203 stores the message MSGc+, which includes the CopyFlag indicating the data copying and the MemInfo indicating the information for identifying the memory 500C, in the transmission queue 230B, as indicated by (1) in FIG. 13. The message receiving unit 203 stores the ACK indicating the completion of reception of the message MSGc in the area indicated by the AckAddr of the function 300B, as indicated by (m) in FIG. 13.

The transmission queue 230B obtains (or extracts) the message MSGc+retained in the head entry of the transmission queue 230B, sets the completion waiting information in the completion waiting queue 240, and changes the CmpAddr in the completion waiting information to the CmpBase, as indicated by (n) in FIG. 13. Then, the transmission queue 230B deletes the CopyFlag and the MemInfo from the message MSGc+obtained (or extracted) from the head entry of the transmission queue 230B to generate the message MSGc', and transmits the message MSGc' to the function 400C, as indicated by (o) in FIG. 13.

The function 400C, which receives the message MSGc', writes the ACK in the area of the message management device 200 indicated by the AckAddr of the message MSGc', as indicated by (p) in FIG. 13. The function 400C accesses the storage area of the memory 500C indicated by the DataAddr included in the message MSGc', and copies the data having the data length indicated by the DataLen, as indicated by (q) in FIG. 13. After the completion of the data copying, the function 400C writes the data transfer complete CMP in the completion flag Cmp indicated by the CmpAddr (=CmpBase) of the message MSGc', as indicated by (r) in FIG. 13. The function 400C starts the data processing using the copied data, as indicated by(s) in FIG. 13.

The completion waiting queue 240, which receives the data transfer complete CMP, releases the area retaining the data in the memory 500C, and evicts the head entry (the completion waiting information) of the completion waiting queue 240, as indicated by (t) in FIG. 13. Accordingly, the processing of the single-cast message MSGc for the case where the data is copied to the memory 500C is completed.

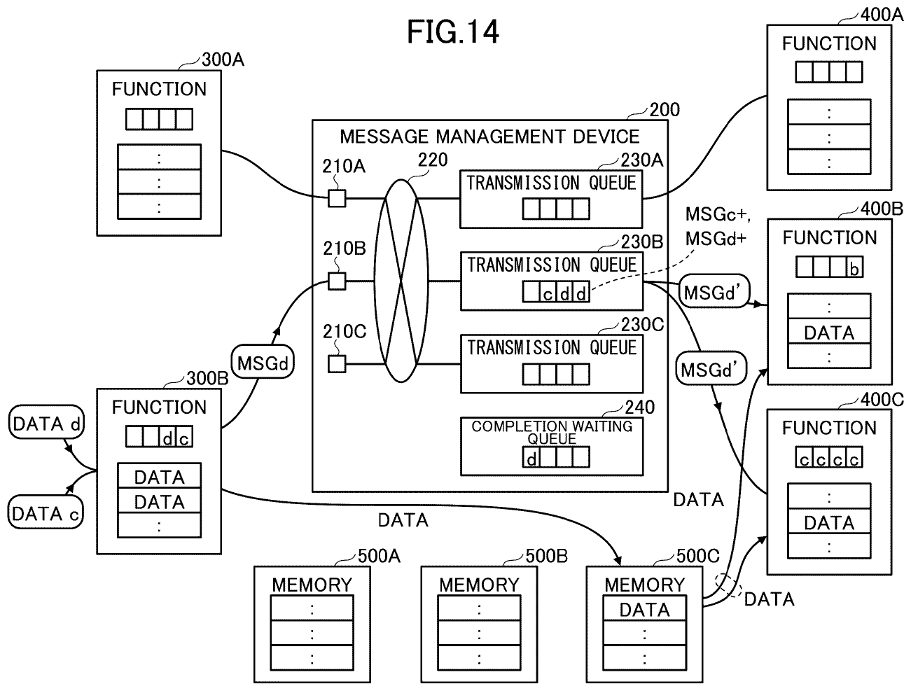

FIG. 14 illustrates another example of the operation of the information processing apparatus 100 illustrated in FIG. 4. In FIG. 14, in a state where the data retaining unit of the function 300B has an insufficient storage capacity, a multicast message MSGd is transmitted from the function 300B to the functions 400B and 400C. Because the storage capacity of the data retaining unit of the function 300B is insufficient, the data to be processed by the functions 400B and 400C is transferred from the function 300B to the functions 400B and 400C via the memory 500C, for example.

In a case where the message management device 200 successively transfers the data from the function 300B to the functions 400B and 400C via the memory 500C, the message management device 200 stores completion waiting information d corresponding to the message MSGd in the completion waiting queue 240. In addition, the message management device 200 successively transmits, to the functions 400B and 400C, a message MSGd' in which the AckAddr indicating the storage destination of the data transmission complete notification for each of the functions 400B and 400C is rewritten to the addresses CmpBase and CmpBase+1 of the completion waiting information, for example. The message management device 200, in response to receiving the data transmission complete notification from both of the functions 400B and 400C, evicts the head entry (the completion waiting information d) of the completion waiting queue 240.

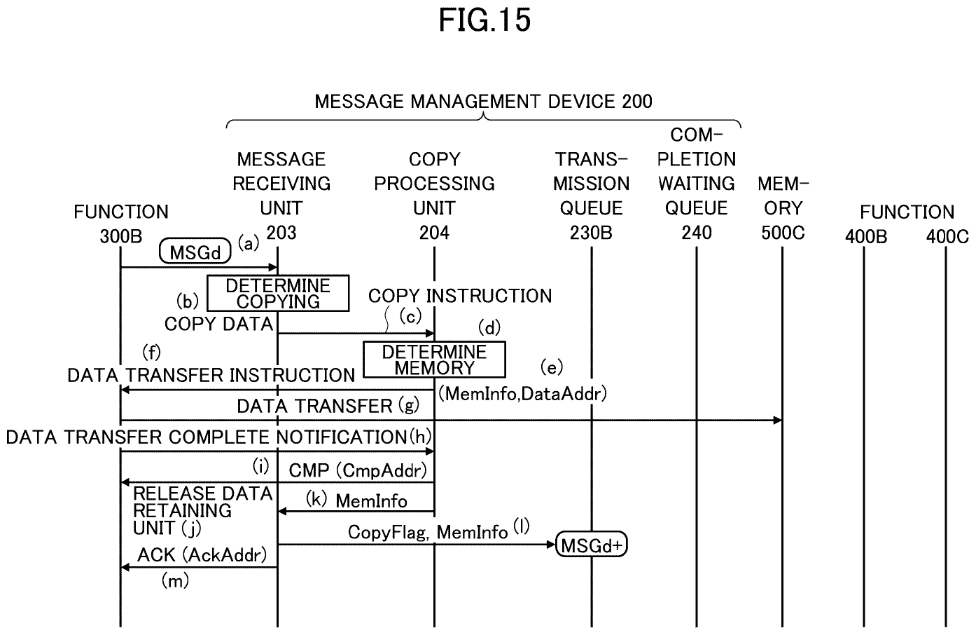

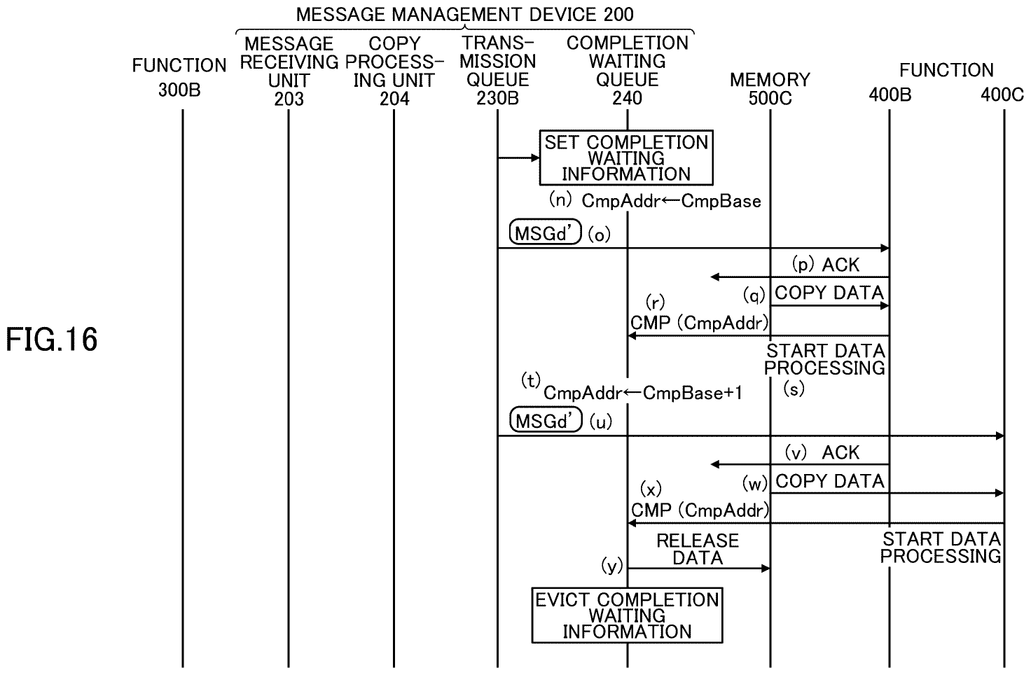

FIG. 15 and FIG. 16 are sequence diagrams illustrating the operation illustrated in FIG. 14. A detailed description of the same operations as those illustrated in FIG. 11 or FIG. 13 will be omitted. The operation illustrated in FIG. 15 is the same as the operation illustrated in FIG. 13 from a time when the message receiving unit 203 stores the message MSGd+ including the CopyFlag and the MemInfo in the transmission queue 230B, to a time when the ACK is stored in the function 300B.

Next, in FIG. 16, similar to FIG. 13, the transmission queue 230B sets the completion waiting information in the completion waiting queue 240, as indicated by (n) in FIG. 16. Then, the transmission queue 230B transmits the message MSGd' in which the CmpAddr in the completion waiting information is changed to the CmpBase to the function 400B, as indicated by (o) in FIG. 16. The function 400B, which receives the message MSGd', writes the ACK in the area of the message management device 200 indicated by the AckAddr of the message MSGd', as indicated by (p) in FIG. 16.

The function 400B copies the data from the memory 500C indicated by the DataAddr included in the message MSGd', as indicated by (q) in FIG. 16. After the completion of the data copying, the function 400B writes the data transfer complete CMP in the completion flag Cmp indicated by the CmpAddr (=CmpBase) of the message MSGd', as indicated by (r) in FIG. 16. The function 400B starts the data processing using the copied data, as indicated by(s) in FIG. 16.

In the case where the data transfer complete CMP is written in the completion flag Cmp, the transmission queue 230B changes the CmpAddr in the completion waiting information to the CmpBase+1, as indicated by (t) in FIG. 16. Further, the transmission queue 230B generates the message MSGd', and transmits the message MSGd' to the function 400C, as indicated by (u) in FIG. 16.

By changing the CmpAddr to the CmpBase before the message MSG is transmitted to the function 400, each function 400 can write the data transfer complete CMP in mutually different areas by referring to a common CmpAddr.

The function 400C, which receives the message MSGd', writes the ACK in the message management device 200, and copies the data from the memory 500C, as indicated by (v) and (w) in FIG. 16, similar to FIG. 13. After the completion of the data copying, the function 400C writes the data transfer complete CMP in the completion flag Cmp indicated by the CmpAddr (=CmpBase+1) of the message MSGd', as indicated by (x) in FIG. 16.

The completion waiting queue 240, which receives the data transfer complete CMP a number of times equal to the number of multicasts, releases the area retaining the data in the memory 500C, and evicts the head entry (the completion waiting information) of the completion waiting queue 240, as indicated by (y) and (z) in FIG. 16. Hence, the processing of the multicast message MSGd for the case where the data is copied to the memory 500C is completed.

By releasing the storage area of the memory 500 in the case where the data transfer complete CMP is written from all of the functions 400 which receive the message MSG, all of the functions 400 can transfer the data before the memory 500 is released.

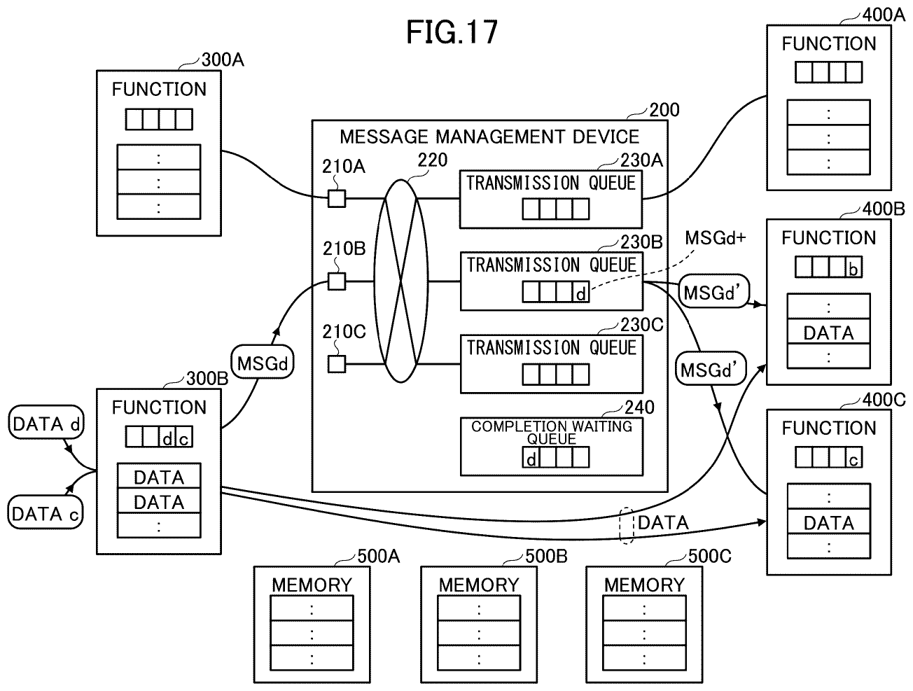

FIG. 17 illustrates another example of the operation of the information processing apparatus 100 illustrated in FIG. 4. In FIG. 17, in the state where the data retaining unit of the function 300B has a sufficient storage capacity, the multicast message MSGd is transmitted from the function 300B to the functions 400B and 400C. Because the data retaining unit of the function 300B has the sufficient storage capacity, the data to be processed by the functions 400B and 400C is successively transferred from the function 300B to the functions 400B and 400C and not via the memory 500.

In the case where the multicast message MSGd is transmitted to the functions 400B and 400C, the message management device 200 stores the completion waiting information d corresponding to the message MSGd in the completion waiting queue 240, regardless of whether or not the data retaining unit of the function 300B has a sufficient storage capacity. Similar to FIG. 14, the message management device 200 successively rewrites the AckAddr indicating the storage destination of the data transmission complete notification from the functions 400B and 400C to the addresses CmpBase and CmpBase+1 of the completion waiting information retained in the completion waiting queue 240.

Further, the message management device 200 successively transmits the message MSGd' in which the CmpAddr is rewritten to the CmpBase or the CmpBase+1 to the functions 400B and 400C, similar to FIG. 14. The message management device 200 deletes the completion waiting information d retained in the completion waiting queue 240 when the data transmission complete notification is received from both the functions 400B and 400C.

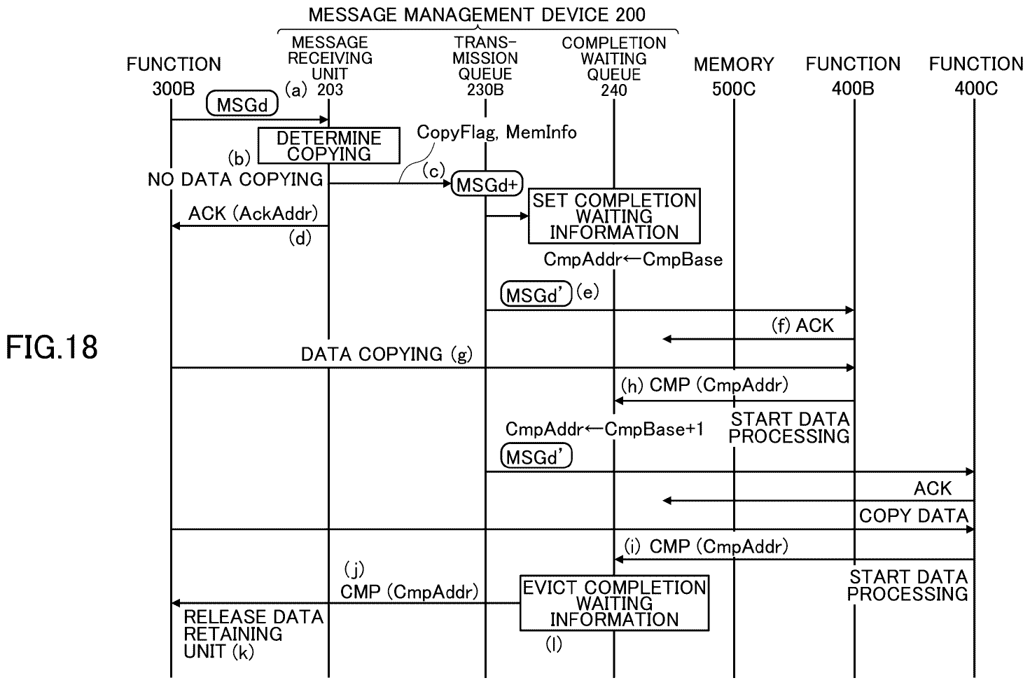

FIG. 18 is a sequence diagram illustrating the operation illustrated in FIG. 17. A detailed description of the same operations as those illustrated in FIG. 11, FIG. 15, or FIG. 16 will be omitted. The operation illustrated in FIG. 18 is the same as the operation illustrated in FIG. 11 from a time when the message receiving unit 203 stores the message MSGd+ in the transmission queue 230B, to a time when the ACK is stored in the area indicated by the AckAddr of the function 300B. The operation from the time when the transmission queue 230B sets the completion waiting information in the completion waiting queue 240 to the time when the function 400C writes the data transfer complete CMP in the completion waiting queue 240 is the same as that illustrated in FIG. 16, except that the data is copied from the function 300B.

The completion waiting queue 240, which receives the data transfer complete CMP the same number of times as the number of multicasts, writes the data transfer complete CMP in the area in the function 300B indicated by the CmpAddr of the message MSGd, as indicated by (i) and (j) in FIG. 18. The function 300B, which receives the data transfer complete CMP, releases the area retaining the data in the data retaining unit, as indicated by (k) in FIG. 18. Then, the completion waiting queue 240 evicts the head entry (the completion waiting information) of the completion waiting queue 240, and the processing of the multicast message MSGd for the case where the data is not copied to the memory 500C is completed, as indicated by (l) in FIG. 18.

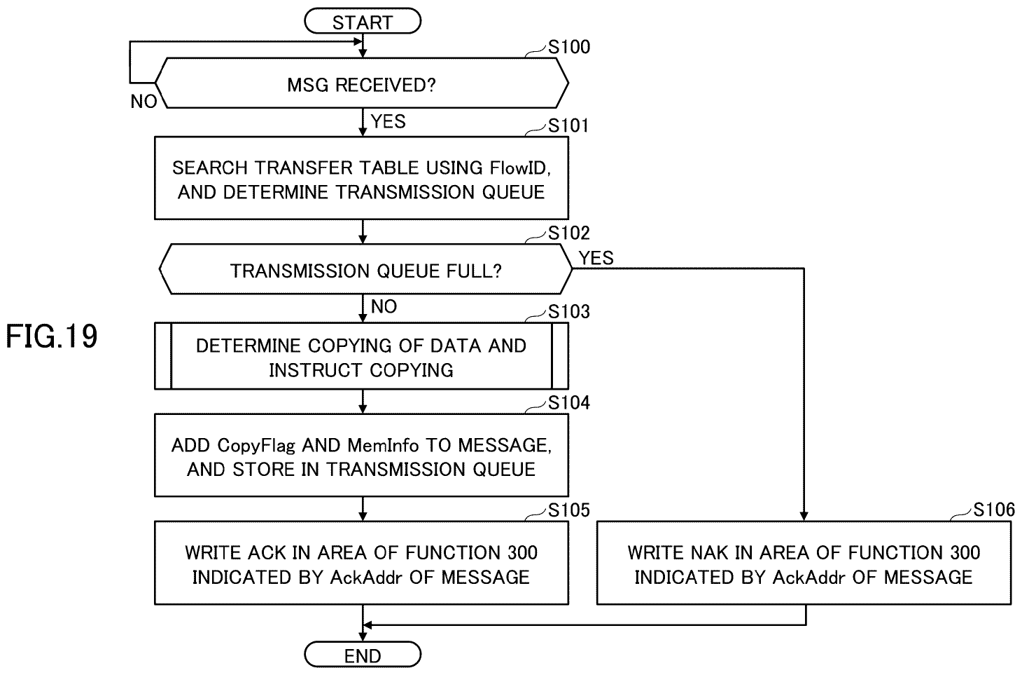

FIG. 19 illustrates an example of an operation flow of the message receiving unit 203 illustrated in FIG. 6. The message receiving unit 203 repeatedly performs the operation illustrated in FIG. 19. First, in step S100, the message receiving unit 203 waits until the message MSG is received, and in a case where the message MSG is received, the message receiving unit 203 performs a process of step S101. In step S101, the message receiving unit 203 searches the transfer table 202 using the FlowID included in the received message MSG, and determines the transmission queue 230 in which the message MSG is to be stored.

Next, in step S102, the message receiving unit 203 determines whether or not the transmission queue 230 determined in step S101 is full. The message receiving unit 203 performs step S106 in a case where the transmission queue 230 is full, and performs step S103 when the transmission queue 230 has a vacant area.

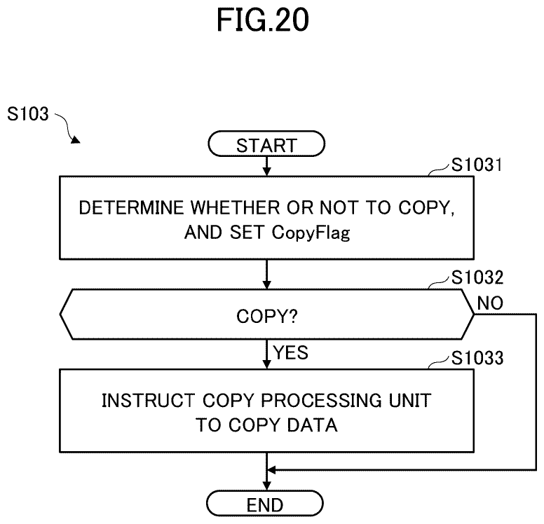

In step S103, the message receiving unit 203 determines to copy the data from the function 300 to the memory 500, and instructs the copy processing unit 204 to copy the data. An example of step S103 is illustrated in FIG. 20. Next, in step S104, the message receiving unit 203 adds the CopyFlag and the MemInfo to the message MSG to obtain the message MSG+, and stores the message MSG+ in the transmission queue 230 determined in step S101.

Next, in step S105, the message receiving unit 203 writes the ACK, indicating the receipt of the message MSG, in the area of the function 300 indicated by the AckAddr included in the message MSG, and ends the operation illustrated in FIG. 19. On the other hand, in step S106, the message receiving unit 203 writes the NAK, indicating not to receive the message MSG, in the area of the function 300 indicated by the AckAddr included in the message MSG, and ends the operation illustrated in FIG. 19.

FIG. 20 illustrates an example of an operation flow of step S103 illustrated in FIG. 19. First, in step S1031, the message receiving unit 203 determines whether or not to perform the data copying. In the case where the message receiving unit 203 performs the data copying, the message receiving unit 203 sets the CopyFlag to be added to the message MSG to a value (for example, is set to “1”) indicating that the data copying is to be performed. In the case where the data copying is not performed, the message receiving unit 203 sets the CopyFlag to be added to the message MSG to a value indicating no data copying (for example, is reset to “0”).

For example, the message receiving unit 203 determines to perform the data copying in a case where one or more determination conditions among the following determination conditions DC1 through DC4 are satisfied.

Determination Condition DC1: The prediction value of the residence time of the message MSG exceeds the first time.

Determination Condition DC2: “Forced copy” is specified in the Info area of the message MSG.

Determination Condition DC3: “Forced Copy” is specified in the transmission queue 230.

Determination Condition DC4: The data size to be copied is larger than a first size specified in the transmission queue 230.

The prediction value of the residence time of the message MSG may be calculated from the following formula (1).

(Prediction value of residence time)=(Number of messages MSG stored in transmission queue 230)/(average speed) (1)

The number of messages MSG stored in the transmission queue 230 increases in a case where the processing speed of the function 400 (receiving device), which is the transmitting destination of the message MSG, is slow or when a load increases, and the messages MSG are retained in the transmission queue 230. The average speed indicates an amount of data transmitted from the transmission queue 230 to the function 400 per unit time. For example, in a case where the amount of data to be processed is large and a long processing time is required, the processing speed becomes slow. The average speed may indicate the number of messages MSG transmitted from the transmission queue 230 to the function 400 per unit time.

The message receiving unit 203 can easily predict the residence time of each message MSG stored in the transmission queue 230, using the formula (1), and can quickly determine whether or not to copy the data from the function 300 to the memory 500. Further, the message receiving unit 203 can appropriately determine whether or not to copy the data from the function 300 to the memory 500, using the determination conditions DC1 through DC4, regardless of whether the message MSG is multicast or single-cast. As a result, it is possible to prevent a delay in transmitting the message MSG from the function 300.

The data size determined by the determination condition DC4 may be a data size corresponding to each message MSG, or may be a total of data sizes corresponding to a plurality of messages MSG stored in the transmission queue 230.

By copying the data to the memory 500 according to the determination condition, it is possible to reduce a delay in the processing of another function 400 caused by the delay in the processing of a specific function 400. In the case where the message MSG is multicast, because a plurality of functions 400 acquire the data, the data may be copied to the memory 500 having a bandwidth larger than that of the memory within the function 300.

In step S1032, in the case where the message receiving unit 203 determines to perform the data copying in step S1031, the message receiving unit 203 performs a process of step S1033. In the case where the message receiving unit 203 determines not to perform the data copying, the operation illustrated in FIG. 20 ends, and the process proceeds to the operation in step S104 illustrated in FIG. 19. In step S1033, the message receiving unit 203 instructs the copy processing unit 204 to perform the data copying, and the operation illustrated in FIG. 20 is ended, and the process proceeds to the operation of step S104 illustrated in FIG. 19.

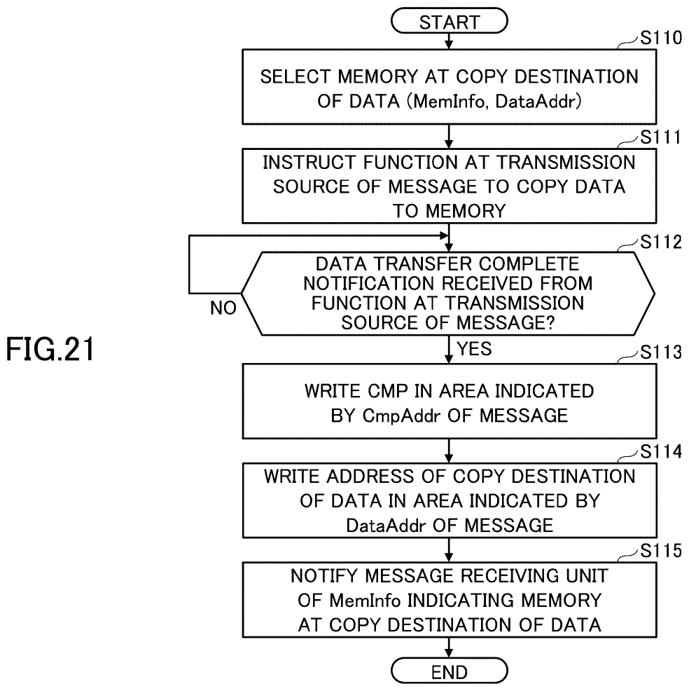

FIG. 21 illustrates an example of an operation flow of the copy processing unit 204 illustrated in FIG. 6. First, in step S110, the copy processing unit 204 selects the memory 500 to which the data from the function 300 is to be copied. The copy processing unit 204 manages the selected memory 500 as the MemInfo, and manages the head address of the area for storing the data in the selected memory 500 as the DataAddr.

The copy processing unit 204 selects the memory 500 according to the following selection conditions SC1 through SC4. For example, the selection conditions SC1 through SC4 may have priorities that are successively increased in this order so that the selection condition SC4 has the highest priority.

Selection Condition SC1: The memory 500 at a copy destination of the data is specified in the Info area of the message MSG.

Selection Condition SC2: The memory 500 at the copy destination of the data is specified in the transmission queue 230.

Selection Condition SC3: The memory 500 of a preset default is selected.

Selection Condition SC4: In a case where the storage capacity for copying the data in the selected memory 500 is insufficient, another memory to which the data can be copied is selected from the memories 500 that are managed.

The copy processing unit 204 may select the memory 500 close to the function 300 (for example, the memory 500 to which the data can be transferred fastest from the function 300), in order to release the data retaining unit of the function 300 which transmits the message MSG at an early stage. In addition, the copy processing unit 204 may select the memory 500 close to the function 400 (for example, the memory 500 which can transfer the data fastest to the function 400), in order to advance an arrival time of the data to the function 400. Further, the copy processing unit 204 may select the memory 500 having a relatively wide bandwidth. For example, in the case where the message MSG is multicast, the memory 500 having the widest bandwidth is preferably selected.

By selecting the memory 500 to which the data is to be copied according to the selection conditions SC1 through SC4, the storage area of the function 300 that retains the data to be copied to the memory 500 can be released quickly. Alternatively, the data can be transferred quickly to the function 400.

Next, in step S111, the copy processing unit 204 instructs the function 300 at the transmission source of the message MSG to copy the data to the memory 500. Next, in step S112, the copy processing unit 204 waits until the data transmission complete notification is received from the function 300 at the transmission source of the message MSG, and performs a process of step S113 in a case where the data transmission complete notification is received.

In step S113, the copy processing unit 204 writes the data transfer complete CMP in the area in the function 300 indicated by the CmpAddr of the message MSG. Next, in step S114, the copy processing unit 204 writes the head address of the area that is to store the data in the memory 500 at the copy destination of the data, in the area indicated by the DataAddr of the message MSGc. Next, in step S115, the copy processing unit 204 notifies the message receiving unit 203 of the MemInfo indicating the memory 500C at the copy destination of the data, and ends the operation illustrated in FIG. 21.

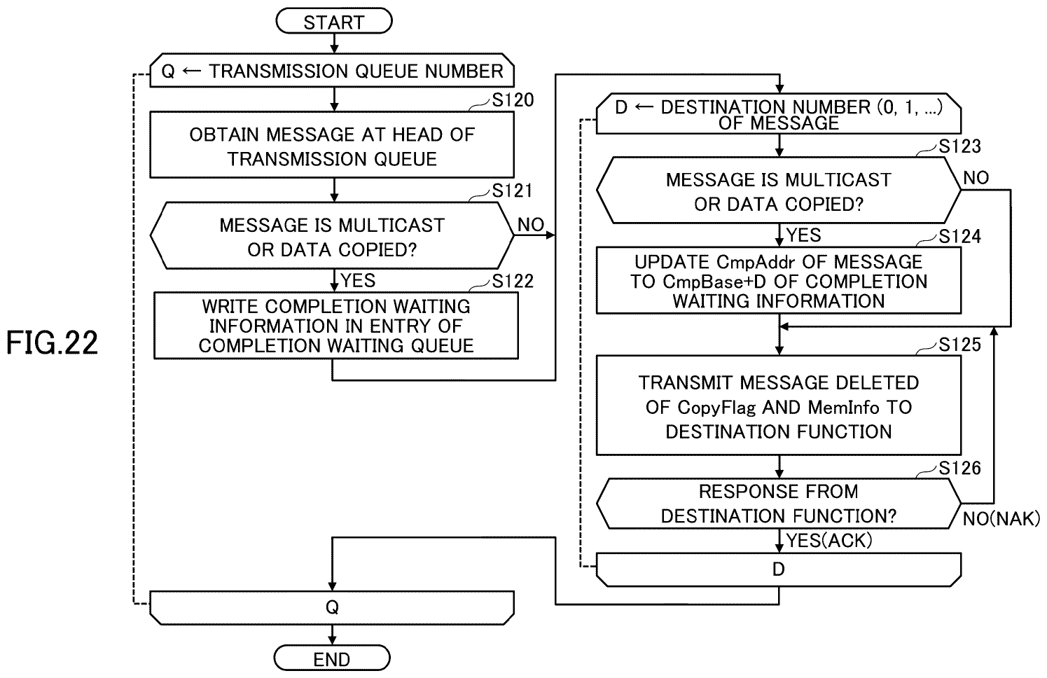

FIG. 22 illustrates an example of an operation flow of the message transmitting unit 206 illustrated in FIG. 6. The operation illustrated in FIG. 22 is repeatedly performed by successively selecting a plurality of transmission queues 230A, 230B, and 230C identified by a transmission queue number Q, for example.

First, in step S120, the message transmitting unit 206 obtains (or extracts) the message MSG+at the head of the transmission queue 230 indicated by the transmission queue number Q. Next, in step S121, the message transmitting unit 206 determines whether or not the message MSG+ is multicast, based on a setting of the transmission queue 230. In addition, the message transmitting unit 206 determines whether or not the data to be processed by the function 400 at the transmitting destination of the message MSG+ has been copied to the memory 500, based on the CopyFlag of the message MSG+.

The message transmitting unit 206 performs a process of step S122 in the case where the message MSG+ is multicast or the data has been copied, and performs a process of step S123 in the case where the message MSG+ is single-cast and the data is not copied. In step S122, the message transmitting unit 206 writes the completion waiting information illustrated in FIG. 7 in the entry of the completion waiting queue 240, and performs the process of step S123.

The processes of steps S123 through S126 are repeatedly performed for each destination number D of the message MSG+. For example, in the case of the single-cast message MSG+, the destination number D is only “0”, and thus, a loop from step S123 to step S126 is performed only once. In the case of the multicast message MSG+, the same number of loops as the number of multicasts are performed.

In step S123, the message transmitting unit 206 performs a process of step S124 in the case where the message MSG+ is multicast or when data has been copied. In the case where the message MSG+ is single-cast and the data is not copied, the message transmitting unit 206 performs a process of step S125. In step S124, the message transmitting unit 206 changes the CmpAddr of the message MSG+to the CmpBase+D of the completion waiting information retained in a target entry of the completion waiting queue 240, and performs the process of step S125.

In step S125, the message transmitting unit 206 generates the message MSG' by deleting the CopyFlag and the MemInfo from the message MSG+, and transmits the message MSG' to the function 400 at the destination. Next, in step S126, the message transmitting unit 206 waits for the response ACK from the function 400 at the destination to which the message MSG' is transmitted. In a case where the response ACK is received, the message transmitting unit 206 succeeded in transmitting the message MSG'. Hence, the message transmitting unit 206 returns the process to step S123 and performs the transmission process to the next destination in the case where the message MSG' is multicast, and exits from the transmission process in the case where the message MSG' is single-cast. In a case where the response ACK is not received, the message transmitting unit 206 performs the process of step S125 again by regarding the response as NAK.

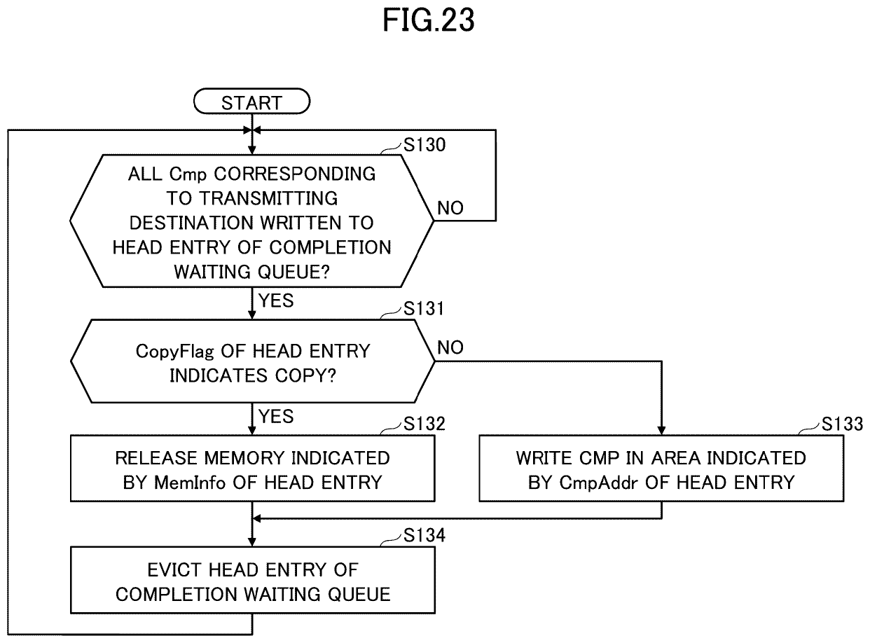

FIG. 23 illustrates an example of the operation flow of the completion waiting queue 240 illustrated in FIG. 6. The completion waiting queue 240 operates in the case where the data is copied to the memory 500, or in the case where the message MSG is multicast.

First, in step S130, the completion waiting queue 240 waits for all of the completion flags Cmp corresponding to the transmitting destinations of the message MSG' to be written in the head entry of the completion waiting queue 240.

In a case where all of the completion flags Cmp are written, the completion waiting queue 240 performs a process of step S131. In step S131, the completion waiting queue 240 determines whether or not the CopyFlag at the head entry indicates the data copying, and performs a process of step S132 in a case where the CopyFlag indicates the data copying, and performs a process of step S133 in a case where the CopyFlag indicates no data copying.

In step S132, the completion waiting queue 240 releases the memory 500 indicated by the MemInfo of the head entry, and performs a process of step S134. In step S133, the completion waiting queue 240 writes the data transfer complete CMP in the area of the function 300 indicated by the CmpAddr at the head entry, and performs a process of step S134. In step S134, the completion waiting queue 240 evicts the head entry, and the process returns to step S130.

By providing the CopyFlag which is referable from the completion waiting queue 240, the completion waiting queue 240 can release the storage area of the memory 500 based on the reception of the data transfer complete notifications from all the functions 400 in the case of the multicast with data copying. On the other hand, the completion waiting queue 240 can release the storage area retaining the data in the function 300 based on the reception of the data transfer complete notification from all of the functions 400 in the case of the multicast without data copying. Accordingly, the storage area retaining the data can be released quickly during both the data transfer complete notification associated with the data transfer from the function 300 to the memory 500, and the data transfer complete notification associated with the data transfer from the memory 500 to the function 400.

As described heretofore, this embodiment can obtain the same effects as those obtainable in the embodiment described above. For example, the message management device 200 copies the data to be processed by the receiving function 400C in which the process is delayed, from the transmitting function 300B to the memory 500, and causes the function 400 to acquire the data. Hence, it is possible to reduce the delay in the data processing of another function 400B which receives the data from the function 300. As a result, it is possible to prevent the processing performance of the information processing apparatus 100 including the plurality of functions 300 and 400 from deteriorating.

Further, in this embodiment, in the case where the message management device 200 receives the multicast message MSG, the message management device 200 stores the completion waiting information in the completion waiting queue 240. The completion waiting information includes the completion flag Cmp in which the data transfer complete notification from each of the functions 400 which receive the message MSG is written. In the case where the data transfer complete notification is received from all of the functions 400 which receive the message MSG, the completion waiting queue 240 releases the storage area of the memory 500 retaining the data, and thereafter evicts the completion waiting information from the completion waiting queue 240. Accordingly, all of the functions 400 which receive the message MSG can transfer the data before the memory 500 is released.

Before transmitting the multicast message MSG to each of the functions 400, the message transmitting unit 206 changes the CmpAddr indicating the address of the area in which the data transfer complete notification is written in the completion waiting information to the address CmpBase of each completion flag Cmp in the completion waiting information. Thus, each of the functions 400 can write the data transmission complete notification in mutually different completion flags Cmp after transferring the data from the memory 500, by referring to the area of the CmpAddr common to the plurality of functions 400 in the completion waiting information.

The CopyFlag indicating whether or not the data is copied from the function 300 to the memory 500 is provided in the completion waiting information so as to be referable from the completion waiting queue 240. Thus, in the case of the multicast with data copying, the completion waiting queue 240 can release the storage area of the memory 500 based on the reception of the data transfer complete notifications from all of the functions 400. On the other hand, in the case of the multicast without data copying, the completion waiting queue 240 can release the storage area retaining the data in the function 300 based on the reception of the data transfer complete notification from all of the functions 400. Accordingly, the storage area in which the data is retained can be released quickly during both the data transfer complete notification associated with the data transfer from the function 300 to the memory 500 and the data transfer complete notification associated with the data transfer from the memory 500 to the function 400.

In the case of the single-cast with data copying, when the copy processing unit 204 receives the data transfer complete notification from the function 300, the copy processing unit 204 writes the data transfer complete CMP in the area within the function 300 indicated by the CmpAddr of the message MSG. Hence, it possible to quickly release the storage area of the function 300B after the data transfer from the function 300 to the memory 500.

The message receiving unit 203 can easily predict the residence time of each message MSG stored in the transmission queue 230, using the formula (1), and can quickly determine whether or not to copy the data from the function 300 to the memory 500. In addition, the message receiving unit 203 can appropriately determine whether or not to copy the data from the function 300 to the memory 500, using the determination conditions DC1 through DC4, regardless of whether the message MSG is multicast or single-cast. As a result, it is possible to prevent a delay in the transmission of the message MSG from the function 300.

The copy processing unit 204 selects the memory 500 to which the data is to be copied according to the selection condition SC1 through SC4. Accordingly, it possible to quickly release the storage area of the function 300 retaining the data to be copied to the memory 500. Alternatively, it is possible to quickly transfer the data to the function 400.

According to the embodiments, it is possible to prevent, even in a case where a process of a receiving device is delayed, a delay in a process of another receiving device which receives a message transmitted from a transmitting device.

The description above use terms such as “determine”, “identify”, or the like to describe the embodiments, however, such terms are abstractions of the actual operations that are performed. Hence, the actual operations that correspond to such terms may vary depending on the implementation, as is obvious to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data transfer controller comprising:
a receiver configured to receive, from a transmitting device, a message including a destination identifying a receiving device which acquires data from a storage area and processes the acquired data, and an address indicating a storage destination of the data to be processed by the receiving device;
a transmission queue configured to retain the message received by the receiver;
a copy processing device configured to instruct the transmitting device to copy the data retained in the transmitting device to a memory, and rewrite an address included in the message retained in the transmission queue to an address indicating a storage location of the data in the memory, based on copying of the data from the transmitting device to the memory; and
a transmitter configured to transmit the message retained at a head of the transmission queue to the receiving device indicated by the destination included in the message.

2. The data transfer controller as claimed in claim 1, further comprising:
a determination device configured to determine whether or not a residence time of the message in the transmission queue exceeds a first time,
wherein the copy processing device instructs the transmitting device to copy the data to the memory in a case where the determination device determines that the residence time exceeds the first time, and rewrites the address included in the message retained in the transmission queue to the address indicating the storage location of the data in the memory, based on the copying of the data from the transmitting device to the memory.

3. The data transfer controller as claimed in claim 2, further comprising:
a completion waiting queue configured to store completion waiting information in a case where the message is transmitted to a plurality of receiving devices by multicasting, wherein:
the completion waiting information includes a plurality of completion flags to which a complete notification is written when each receiving device of the plurality of receiving devices copies the data from the storage area, and
the completion waiting queue releases the storage area retaining the data and evicts the completion waiting information from the completion waiting queue in a case where the complete notification is written to all of the plurality of completion flags.

4. The data transfer controller as claimed in claim 3, wherein:
the message includes a write address to which the complete notification is written in a case where the receiving device copies the data from the storage area, and
the transmitter rewrites the write address of the message to an address indicating positions of the plurality of completion flags before transmitting the message to each receiving device of the plurality of receiving devices in a case where the message is multicast.

5. The data transfer controller as claimed in claim 3, wherein:
the completion wait information includes a copy flag which is set when the residence time exceeds the first time and is reset when the residence time does not exceed the first time, and
the completion waiting queue releases the storage area of the memory retaining the data in a case where the complete notification is written to all of the plurality of completion flags wherein the copy flag is set, and releases the storage area of the transmitting device retaining the data in a case where the complete notification is written to all of the plurality of completion flags wherein the copy flag is set.

6. The data transfer controller as claimed in claim 2, wherein the copy processing device releases the storage area of the transmitting device retaining the data in a case where a complete notification of the copying of the data to the memory is received from the transmitting device which transmitted the message by single-casting.

7. The data transfer controller as claimed in claim 2, wherein the determination device sets a value obtained by dividing a number of messages retained in the transmission queue by an amount of data transmitted from the transmission queue to the receiving device per unit time, as the residence time.

8. The data transfer controller as claimed in claim 2, wherein the determination device sets a value obtained by dividing a number of messages retained in the transmission queue by a number of messages transmitted from the transmission queue to the receiving device per unit time, as the residence time.

9. The data transfer controller as claimed in claim 2, wherein:
the message includes a data size of the data to be processed by the receiving device, and additional information, and
the determination device determines that the residence time exceeds the first time in a case where the data size included in the message received by the receiver is larger than a first size, or in a case where the additional information includes information specifying a forced copying of the data to the memory, or in a case where the transmission queue includes information specifying the forced copying of the data to the memory.

10. The data transfer controller as claimed in claim 1, wherein the copy processing device selects a memory to which the data can be transferred fastest from the transmitting device, or a memory to which the data can be transferred fastest to the receiving device, or a memory having a widest bandwidth, as the memory to which the data is to be copied.

11. The data transfer controller as claimed in claim 1, wherein:
the message includes additional information,
the copy processing device selects a specified memory as the memory to which the data is copied in a case where the memory at a copy destination of the data is specified in the additional information, or in a case where the memory at the copy destination of the data is specified in the transmission queue, and
the copy processing device selects another memory to which the data can be copied in a case where a storage capacity of the selected memory is insufficient for copying the data.

12. An information processing apparatus comprising:
a receiving device configured to acquire data from a storage area and processes the acquired data;
a transmitting device configured to transmit a message including a destination for identifying the receiving device, and an address indicating a storage destination of the data to be processed by the receiving device;
a memory; and
a data transfer controller configured to control transfer of the message and the data from the transmitting device to the receiving device,
wherein the data transfer controller includes:
a receiver configured to receive the message from the transmitting device;
a transmission queue configured to retain the message received by the receiver;
a copy processing device configured to instruct the transmitting device to copy the data retained in the transmitting device to a memory, and rewrite an address included in the message retained in the transmission queue to an address indicating a storage location of the data in the memory, based on copying of the data from the transmitting device to the memory; and
a transmitter configured to transmit the message retained at a head of the transmission queue to the receiving device indicated by the destination included in the message.
